(19) United States
(12) Patent Application Publication
(10) Pub. No.: US 2002/0015109 A1
(43) Pub. Date: Feb. 7, 2002

(54) Broadcast receiver apparatus producing and transmitting electronic mail based on data multiplexed on broadcast wave

(76) Inventor: Kenji Mameda, Kashihara-shi (JP)

Correspondence Address: BIRCH STEWART KOLASCH & BIRCH, PO BOX 747, FALLS CHURCH, VA, 22040-0747, US

(21) Appl. No.: 09/898,014

(22) Filed: Jul. 5, 2001

(30) Foreign Application Priority Data
Jul. 7, 2000 (JP) 2000-206400

(51) Int. Cl. H04N 5/44; H04N 5/445

(52) U.S. Cl. 348/553; 348/564

(57) ABSTRACT

A broadcast receiver apparatus includes a video/data separation unit separating video from data included in a broadcast wave, and a CRT displaying the video separated by the video/data separation unit, and displaying a button on the video based on button data included in the separated data. The CRT displays video associated data corresponding to a button selected by a viewer. Therefore, the correspondence between video and video associated data can easily be grasped.

### BACKGROUND OF THE INVENTION

1. Field of the Invention

The present invention relates to the technique of receiving video and data superposed on a broadcast wave and viewing the same. Particularly, the present invention relates to a broadcast receiver apparatus producing electronic mail based on data multiplexed on a broadcast wave to transmit and receive the electronic mail via the Internet, a remote controller controlling the broadcast receiver apparatus, a mail server providing the user with information according to electronic mail from the broadcast receiver apparatus, and a broadcast reception system including such a broadcast receiver apparatus, remote controller, and mail server.

2. Description of the Background Art

The TV (television) set receiving and displaying videos transmitted through broadcast waves are widely available. When the broadcast station side wishes to know about the viewer's response towards a program, a telephone number or address to answer a prize quiz or questionnaire is broadcasted during the program to have viewers respond by telephone or an appropriately addressed postcard. At the broadcast station side, the viewer's opinion and the like are aggregated based on the obtained results.

The dissemination is known of a receiver with a data broadcast reception function that can receive video transmitted through a broadcast wave as well as data multiplexed on the video. Data associated with the broadcasting video is multiplexed on that video to be broadcasted as data broadcast. In general, the user displays that information, when required, on a display screen such as a CRT (Cathode Ray Tube).

To view the broadcasting data, the user depresses a button dedicated to the data broadcast, whereby the mode is switched to the data broadcast mode. Upon entering the data broadcast mode, the data is displayed on the CRT screen with the currently broadcasting video interrupted. Alternatively, the area to display the video is reduced to acquire an area to display the data on the CRT screen.

Japanese Patent Laying-Open No. 9-162818 discloses another technique to obtain data. According to the network service disclosed in Japanese Patent Laying-Open No. 9-162818, signals including URL (Uniform Resource Locators) information of the network service associated with the TV broadcast program are multiplexed on the TV video signals to be transmitted. A receiver receiving the signal connects to an access point corresponding to the URL via the Internet to receive data, whereby a corresponding homepage is displayed on a CRT.

A viewer who wishes to answer a prize quiz or questionnaire broadcasted during a television program must jot down the telephone number or address on air on the TV receiver set, and then place a telephone call or write a postcard to the announced telephone number or address, respectively. At the broadcast station side, the contents of the telephone and postcards from the viewers must be aggregated manually. There was the problem that burden on both the viewer side and the broadcast station side was imposed.

In the case where the mode is switched to the data broadcast mode to display data on a CRT screen using the television broadcast reception function, the relationship between the video and data broadcast becomes indefinite. In other words, when there are a plurality of associated data in the video, the correspondence between video and data broadcast is ambiguous. Since the CRT screen is used for data display when the viewer is to view the data broadcast, the video on air could not be watched or watched only on a small area on the CRT screen. There was a problem that the correspondence is ambiguous.

Even if there is detailed information associated with a program, the broadcast station must suppress the information to a low amount favorable to as many people as possible due to various reasons such as limitation in the amount of data that can be broadcasted, numerous types of data, and the overall preference of the viewers. There was a problem that, when a viewer wants to obtain more detailed information of the broadcasted data, that information must be fetched by other measures.

In the network service disclosed in Japanese Patent Laying-Open No. 9-162818, a Web page must be produced, and information from many users based on the access to the Web page must be stored in the server. The burden on the server is great. There was also the problem that the broadcasting video must be interrupted during the period of time the user is browsing the Web page.

### SUMMARY OF THE INVENTION

An object of the present invention is to provide a broadcast receiver apparatus that allows a viewer to easily keep track of the correspondence between video and video associated data, a remote controller, and a broadcast reception system including such a broadcast receiver apparatus and remote controller.

Another object of the present invention is to provide a broadcast receiver apparatus that allows a viewer to easily obtain detailed information associated with a program, a remote controller, and a broadcast reception system including such a broadcast receiver apparatus and remote controller.

A further object of the present invention is to provide a broadcast receiver apparatus that can automatically produce electronic mail to answer a prize quiz or questionnaire on air, a remote controller, and a broadcast reception system including such a broadcast receiver apparatus and remote controller.

According to an aspect of the present invention, a broadcast receiver apparatus includes a separation unit separating video from data included in a broadcast wave, and a display unit displaying the video separated by the separation unit, and displaying a button on the video based on button data included in the separated data. The display unit displays video associated data corresponding to a button selected by a user.

Since the display unit displays video associated data corresponding to a button selected by the user, the user can easily keep track of the correspondence between video and video associated data.

According to another aspect of the present invention, a broadcast receiver apparatus includes a separation unit separating video from data included in a broadcast wave, and a display unit displaying video separated by the separation unit, and display a button on the video based on button data included in the separated data, a mail production unit referring to button data corresponding to the button selected by the user to produce electronic mail, and a mail transmission unit transmitting the electronic mail produced by the mail production unit.

Since the mail production unit refers to button data corresponding to the button selected by the user to produce electronic mail, electronic mail required to request detailed information associated with a program can be easily produced. Also, electronic mail to answer a prize quiz or questionnaire on air can be produced.

According to a further aspect of the present invention, a broadcast receiver apparatus includes a separation unit separating video from data included in a broadcast wave, a display unit displaying the video separated by the separation unit, and a communication unit receiving an externally applied command to transmit video associated data included in the data separated by the separation unit to an external source.

Therefore, video associated data can be displayed on the display unit on an apparatus of an external source.

According to still another aspect of the present invention, a broadcast receiver apparatus includes a separation unit separating video from data included in a broadcast wave, a display unit displaying the video separated by the separation unit, a first communication unit receiving an externally applied command to transmit button data included in the data separated by the separation unit, and receive electronic mail from an external source, and a second communication unit transmitting the electronic mail received by the first communication unit.

Information required to produce electronic mail can be transmitted to an external apparatus, and any received electronic mail can be transmitted through a public circuit.

According to a still further aspect of the present invention, a remote controller includes a communication unit receiving externally applied data and an image, a display unit displaying the image received by the communication unit, and displaying a button on the image based on button data included in the data, and a select unit selecting a button displayed by the display unit. The display unit displays video associated data corresponding to a button selected by the select unit.

Since the display unit displays video associated data corresponding to a selected button, the correspondence between video and video associated data can be easily grasped.

According to yet a further aspect of the present invention, a remote controller includes a communication unit receiving externally applied data and an image, and transmit electronic mail to an external source, a display unit displaying the image received by the communication unit, and displaying a button on the image based on button data included in the data, a select unit selecting a button displayed by the display unit, and a mail production unit referring to button data corresponding to the button selected by the select unit and producing electronic mail.

Since the mail production unit refers to button data corresponding to a selected button to produce electronic mail, electronic mail required to request detailed information associated with a program can be produced easily. Also, electronic mail to answer a prize quiz or questionnaire on air can be produced automatically.

According to yet another aspect of the present invention, a broadcast reception system includes a broadcast apparatus superposing video and data on a broadcast wave for transmission, a broadcast receiver apparatus receiving the broadcast wave transmitted from the broadcast apparatus, and a remote controller controlling the broadcast receiver apparatus. The broadcast receiver apparatus includes a separation unit separating the video from the data included in the broadcast wave transmitted from the broadcast apparatus, a display unit displaying the video separated by the separation unit, and displaying a button on the video based on button data included in the separated data, and a select unit selecting a button displayed by the display unit in response to designation from the remote controller. The display unit displays video associated data corresponding to the button selected by the select unit.

Since the display unit displays video associated data corresponding to the selected button, the correspondence between video and video associated data can be easily grasped.

According to yet a still further aspect of the present invention, a broadcast reception system includes a broadcast apparatus superposing video and data on a broadcast wave for transmission, a broadcast receiver apparatus receiving the broadcast wave transmitted from the broadcast apparatus, a remote controller controlling the broadcast receiver apparatus, and a mail server connected to a public circuit. The broadcast receiver apparatus includes a separation unit separating video from data included in the broadcast wave transmitted from the broadcast apparatus, a display unit displaying the video separated by the separation unit, and displaying a button on the video based on button data included in the separated data, a select unit selecting a button displayed by the display unit according to designation from the remote controller, a mail production unit referring to button data corresponding to a button selected by the select unit, and producing electronic mail, and a mail transmission unit transmitting the electronic mail produced by the mail production unit to the mail server.

Since the mail production unit refers to button data corresponding to a selected button to produce electronic mail, electronic mail required to request detailed information associated with a program can be easily produced. Also, electronic mail to answer a prize quiz or questionnaire on air can be produced automatically.

According to an additional aspect of the present invention, a broadcast reception system includes a broadcast apparatus superposing video and data on a broadcast wave for transmission, a broadcast receiver apparatus receiving the broadcast wave transmitted from the broadcast apparatus, and a remote controller controlling the broadcast receiver apparatus. The broadcast receiver apparatus includes a separation unit separating video from data included in the broadcast wave transmitted from the broadcast apparatus, a first display unit displaying the video separated by the separation unit, and a first communication unit receiving a command from the remote controller to transmit button data included in the data separated by the separation unit, video associated data, and an image to the remote controller. The remote controller includes a second communication unit receiving button data included in the data from the broadcast receiver apparatus, video associated data, and an image, a second display unit displaying the image received by the second communication unit, and displaying a button on the image based on button data included in the data, and a select unit selecting a button displayed by the second display unit. The second display unit displays video associated data corresponding to the button selected by the select unit.

Since the second display unit displays video associated data corresponding to the selected button, the correspondence between video and video associated data can be easily grasped.

According to still an additional aspect of the present invention, a broadcast reception system includes a broadcast apparatus superposing video and data on a broadcast wave for transmission, a broadcast receiver apparatus receiving the broadcast wave transmitted from the broadcast apparatus, a remote controller controlling the broadcast receiver apparatus, and a mail server connected to a public circuit. The broadcast receiver apparatus includes a separation unit separating the video from the data included in the broadcast wave transmitted from the broadcast apparatus, a first display unit displaying the video separated by the separation unit, a first communication unit receiving a command from the remote controller to transmit button data included in the data separated by the separation unit and an image to the remote controller and receiving electronic mail from the remote controller, and a mail transmission unit transmitting the electronic mail received from the remote controller to the mail server. The remote controller includes a second communication unit receiving button data included in the data from the broadcast receiver apparatus and an image, and transmits electronic mail to the broadcast receiver apparatus, a second display unit displaying the image received by the second communication unit, and displaying a button on the image based on button data included in the data, a select unit selecting a button displayed by the second display unit, and a mail production unit referring to button data corresponding to a button selected by the select unit, and producing electronic mail.

Since the mail production unit refers to button data corresponding to the selected button to produce electronic mail, electronic mail required to request detailed information associated with a program can be easily produced. Also, electronic mail to answer a prize quiz or questionnaire on air can be produced automatically.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a schematic structure of a broadcast reception system according to a first embodiment of the present invention.

FIG. 2 shows an appearance of a broadcast receiver apparatus 102 according to the first embodiment.

FIG. 3 shows an appearance of a remote controller 103 of the first embodiment.

FIG. 4 is a block diagram of a schematic structure of a broadcast receiver apparatus 102 of the first embodiment.

FIG. 5 is a flow chart to describe the procedure of broadcast receiver apparatus 102 of the first embodiment.

FIG. 6 shows an example of button data.

FIG. 7 shows an example of electronic mail produced by a mail production unit 208.

FIG. 8 shows another example of button data.

FIG. 9 shows a display of a button superposed on video.

FIG. 10 shows a display of an available region in video.

FIG. 11 is a block diagram of a schematic structure of a broadcast receiver apparatus 102′ according to a second embodiment of the present invention.

FIG. 12 shows an appearance of a remote controller 103′ of the second embodiment.

FIG. 13 is a block diagram of a schematic structure of remote controller 103′ of the second embodiment.

### DESCRIPTION OF THE PREFERRED EMBODIMENTS

First Embodiment

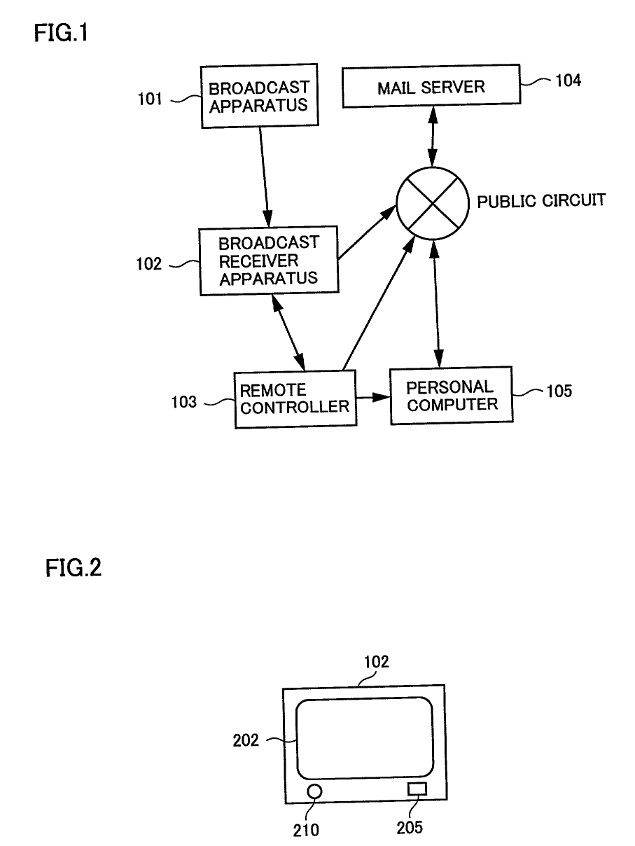

FIG. 1 is a block diagram of a schematic structure of a broadcast reception system according to a first embodiment of the present invention. The broadcast reception system includes a broadcast apparatus 101 superposing video associated data and a video associated button linked with video associated data (simply called “button” hereinafter) on a video signal to broadcast a program, a broadcast receiver apparatus 102 displaying the video, video associated data, and the button linked to video associated data broadcasted by broadcast apparatus 101, and transmitting and receiving electronic mail through a public circuit, a remote controller 103 controlling broadcast receiver apparatus 102 and the like, a mail server 104 transmitting and receiving electronic mail through the public circuit, and a personal computer 105 controlled by remote controller 103.

Broadcast receiver apparatus 102 receives the video, video associated data, and the button linked to video associated data broadcasted by broadcast apparatus 101, and displays the video and the like on a display unit. When display is provided with a button superposed on the video displayed at the display unit of broadcast receiver apparatus 102, the user can operate remote controller 103 to select a button, whereby video associated data corresponding to the selected button, if any, is displayed at the display unit of broadcast receiver apparatus 102, or transmitted to remote controller 103 to be displayed at a display unit on remote controller 103.

When information such as the mail address or a template of electronic mail is added to the button displayed on the display unit of broadcast receiver apparatus 102, the user can operate remote controller 103 to transmit electronic mail from broadcast receiver apparatus 102 to mail server 104 through a public circuit. When remote controller 103 is a composite apparatus with a telephone set that has the function to transmit electronic mail, the electronic mail can be transmitted to mail server 104 directly via the public circuit. Electronic mail can be accumulated in remote controller 103 and then transmitted together to personal computer 105, so that electronic mail can be transmitted to mail server 104 through the public circuit.

The transmitted electronic mail has the mail address of personal computer 105 or the like written therein as the return address. Mail server 104 refers to that mail address to send the requested video associated data to personal computer 105 and the like as electronic mail. Mail server 104 can classify information based on the contents of the electronic mail transmitted from users to produce an aggregation list or the like.

FIG. 2 shows an appearance of a broadcast receiver apparatus of the present embodiment. Broadcast receiver apparatus 102 includes a CRT 202 displaying the received video or the like, an infrared receive/emissive unit 205 transmitting/receiving data to/from remote controller 103 through infrared radiation, and an LED (Light Emitting Diode) 210. When display is provided with a button superimposed on video on CRT 202, a cursor to select the relevant button is also displayed. LED 210 is turned on or blinks when video associated data is received to notify the presence of video associated data to the user. Means to notify the user that video associated data is received is not limited to LED 210. For example, the presence of video associated data may be announced during a program, or a button or a cursor to select a button may be automatically displayed.

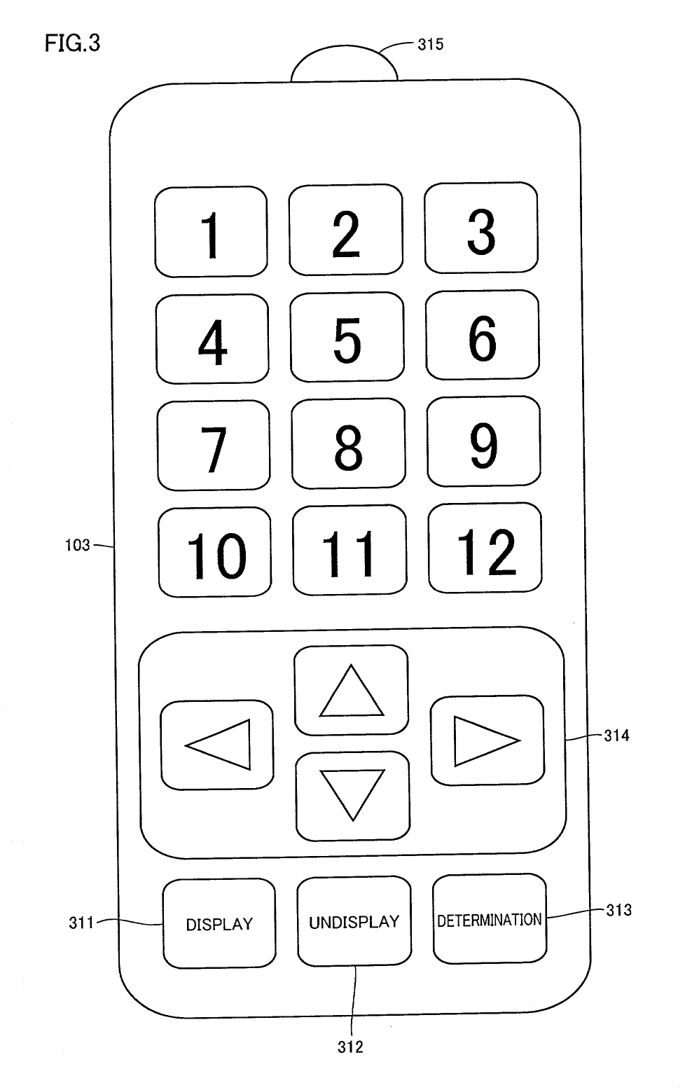

FIG. 3 shows an appearance of remote controller 103 of the present embodiment. Remote controller 103 includes a “display” button 311 designating display of a video associated button and cursor when there is video associated data, an “undisplay” button 312 designating termination of the display of the video associated button and cursor to provide display of only the video, a “determination” button 313 displaying on CRT 202 the contents of video associated data, if any, and designating production of electronic mail when there is no video associated data, a cursor move button 314 designating the moving direction of the cursor, and an infrared receive/emissive unit 315 transmitting/receiving infrared data to/from broadcast receiver apparatus 102 and personal computer 105. Remote controller 103 has a circuit configuration similar to that of a general remote controller. Therefore, detailed description thereof will not be provided.

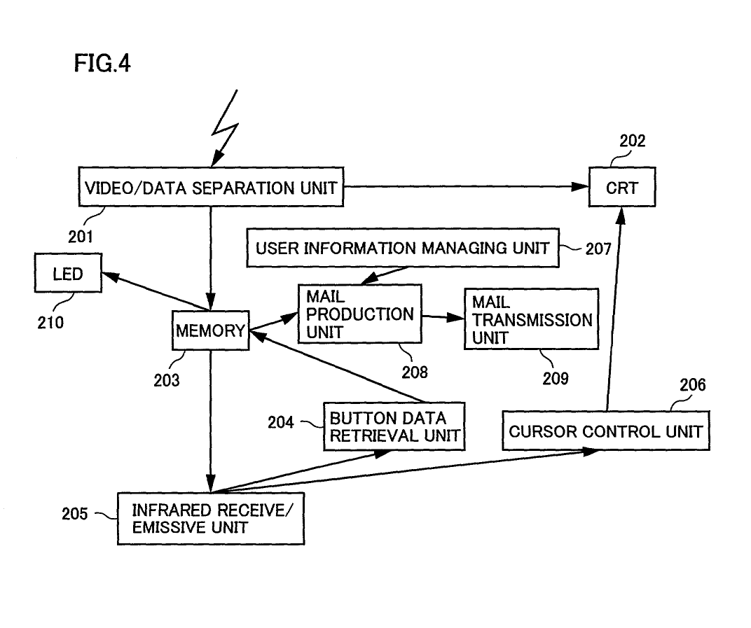

FIG. 4 is a block diagram of a schematic structure of broadcast receiver apparatus 102 of the present embodiment. Broadcast receiver apparatus 102 includes a video/data separation unit 201 receiving a broadcast wave through an antenna not shown to separate a video signal from data, a CRT 202 displaying the received video or the like, a memory 203 storing data (button data, video associated data) separated by video/data separation unit 201, a button data retrieval unit 204 retrieving button data stored in memory 203 according to infrared data transmitted from remote controller 103, an infrared receive/emissive unit 205 transmitting/receiving data to/from remote controller 103 through infrared radiation, a cursor control unit 206 controlling the movement of a cursor displayed on CRT 202 according to the infrared data transmitted from remote controller 103, a user information managing unit 207 managing preregistered user information, a mail production unit 208 referring to user information and the like under control of user information managing unit 207 to produce electronic mail, a mail transmission unit 209 transmitting the electronic mail produced by mail production unit 208, and an LED 210.

Video/data separation unit 201 detects and demodulates the broadcast wave received through an antenna not shown to separate a video signal from a data signal, and provides the video signal to CRT 202. Accordingly, video is displayed on CRT 202. Video/data separation unit 201 reproduces data from the separated data signal and stores the reproduced data in memory 203. Data superimposed on a video signal includes button data and video associated data.

When button data is superposed on a video signal, a button is displayed superposed on the video displayed on CRT 202. The user can select any displayed button. When a button is not actually displayed on CRT 202, LED 210 can be lit as a virtual button, whereby the user is notified that video associated data can be output in addition to the video. As to means notifying the presence of video associated data to the user, the presence of video associated data can be announced during the program, or a cursor to select a button may be displayed by cursor control unit 206. However, this means is not limited thereto.

Infrared receive/emissive unit 205 carries out infrared data communication with remote controller 103 to receive a cursor move command or button select command from remote controller 103. When infrared receive/emissive unit 205 receives a button select command, button data retrieval unit 204 refers to button data stored in memory 203 to retrieve the button located at the cursor position at the time point of button selection. When the button corresponding to the cursor position is in memory 203 and associated data related to that button is present, button data retrieval unit 204 displays the associated data on CRT 202. In the case where a mail address or a template to produce electronic mail is added to that button, the relevant information is transferred to mail production unit 208, and an electronic mail production command is issued.

When button data retrieval unit 204 issues an electronic mail production command, mail production unit 208 extracts the reply mail address from user information managing unit 207 and extracts a mail template from memory 203 as the electronic mail main body to produce electronic mail. Mail transmission unit 209 transmits the electronic mail produced by mail production unit 208 to the mail address attached to the button through a public circuit. It is to be noted that the user can be confirmed about electronic mail transmission prior to transmitting the electronic mail since there are cases where the burden of accounting or the like is imposed on the user in electronic mail transmission.

CRT 202 is employed as the display device of the broadcast receiver apparatus of the present embodiment. However, the display device is not limited thereto. Any device that can display a video, button, a cursor, or the like can be employed such as a liquid crystal display.

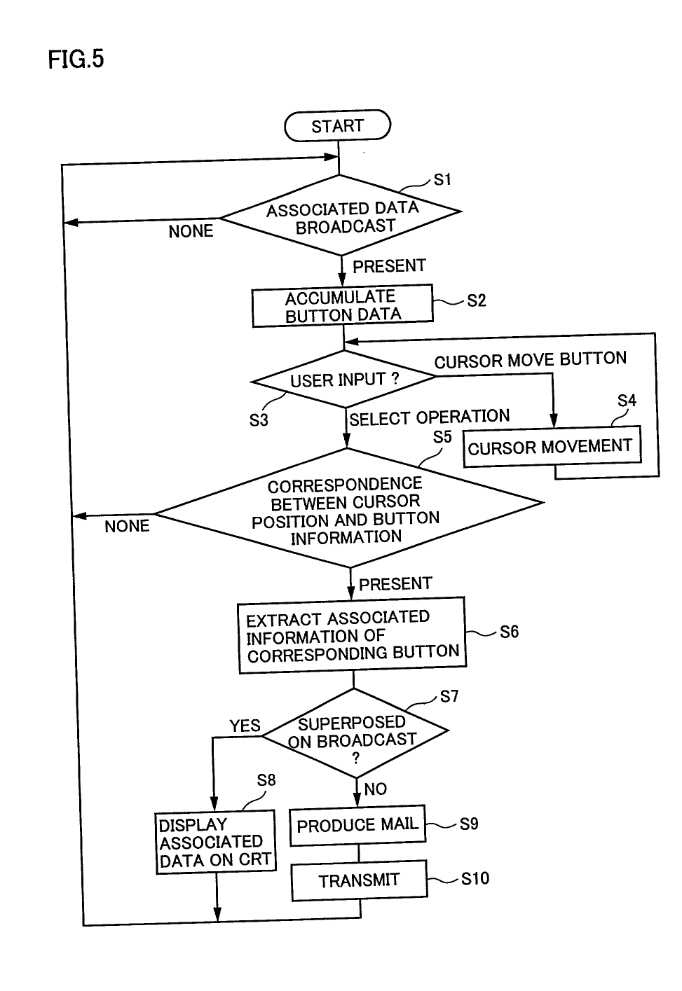

FIG. 5 is a flow chart to describe the procedure of the broadcast receiver apparatus of the present embodiment. First, video/data separation unit 201 determines whether data is superposed on the broadcast wave (S1). When data is not superposed on the broadcast wave (SI: none), control returns to step S1 to repeat the process. When data is superposed on the broadcast wave (S1: present), video/data separation unit 201 stores button data and the like in memory 203 (S2).

Then, determination is made whether designation from a user is input through infrared receive/emissive unit 205. In the case where the user has depressed the cursor move button of remote controller 103 (S3: cursor move button), infrared receive/emissive unit 205 issues a cursor move command to cursor control unit 206 (S4). Upon receiving a cursor move command, cursor control unit 206 moves the cursor in the direction designated by the user.

When the user operates remote controller 103 to select a button (S3: select operation), button data retrieval unit 204 determines whether there is correspondence between the cursor position and the button (S5). When there is no correspondence between the cursor position and the button (S5: none), control returns to step S1 to repeat the subsequent process. When there is correspondence between the cursor position and button (S5: present), button data retrieval unit 204 extracts information related to the corresponding button (video associated data) from memory 203.

When there is video associated data in memory 203 (S7: Yes), the extracted video associated data is displayed on CRT 202 (S8). When there is no video associated data corresponding to the button in memory 203 (S7: No), information of electronic mail corresponding to that button is present. Therefore, mail production unit 208 produces electronic mail from the electronic mail template attached to that button (S9). Then, mail transmission unit 209 transmits the produced electronic mail (S10).

Reception of an actually broadcasted program by broadcast receiver apparatus 102 of the present embodiment will be described hereinafter.

Program Example 1

The case where a TV shopping program is broadcasted as an example of a program to be received will be described.

In TV shopping, explanation of a product is provided by the broadcasting video. It is assumed that information such as a more detailed catalog on the explained contents is prestored in mail server 104.

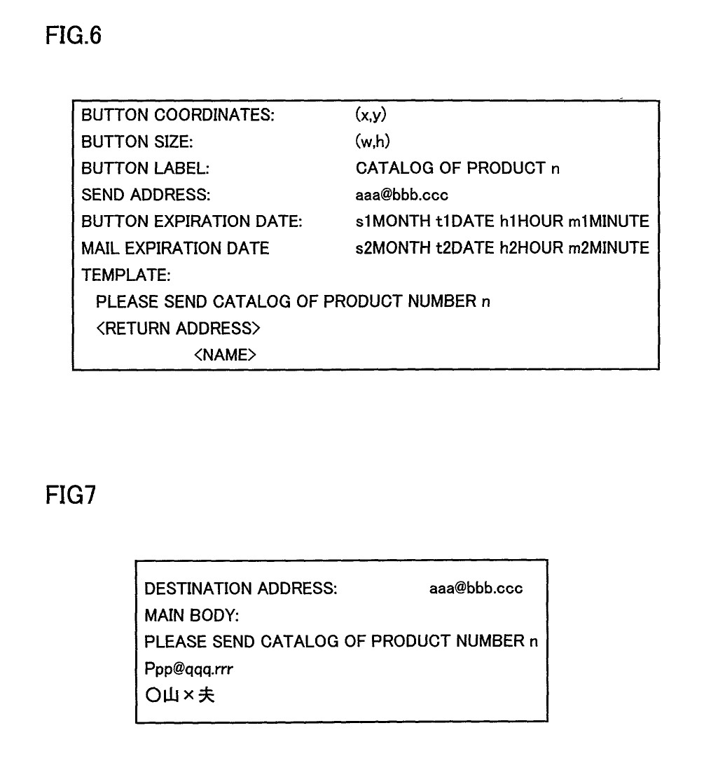

FIG. 6 shows an example of button data used in the TV shopping program. This button data includes button coordinates which are the coordinates for button display, the button size, a button label, an electronic mail transmission address, a button expiration date, an electronic mail expiration date, and an electronic mail template.

The button coordinates (x, y) and the button size (w, h) are set at the position overlaying the product of interest in the video displayed on CRT 202. The button is displayed overlying the video of the product of interest. As the video changes during the program, data of the button coordinates and button size are resent, whereby different button coordinates and button size are set. If the button expiration date is set, the button can be easily eliminated when the button is no longer required in the course of the program.

In the region enclosed by angle brackets <> in the entries in the electronic mail template shown in FIG. 6, user information is written when mail production unit 208 produces electronic mail. The remaining portions in the template are left and used when mail production unit 208 produces electronic mail. Since this template can be determined at the broadcast station side, a format that can be easily processed by mail server 104 when the electronic mail is received is provided. For example, by assigning the first row, second row and third row the product number, return address, and user name, respectively, in the template, immediate recognition can be made that information related to the product written on the first row in the electronic mail is to be transmitted to the address identified on the second row. In the case where a plurality of buttons have a common send address, it is no longer necessary to write a send address in each button by superposing a send address on the video in advance and transmitting the video with the send address.

The user moves the cursor to the product displayed on CRT 202 and selects a button, whereby production of electronic mail by mail production unit 208 starts.

FIG. 7 shows an example of electronic mail produced by mail production unit 208. As the destination address of this electronic mail, the send address attached to the button of FIG. 6 is written. In producing the main text of the electronic mail, a template with the button data of FIG. 6 added is used. As to <return address> in the template, the stored user information is referred to by user information managing unit 207, and the user's mail address is written therein. Also, the user's name is written in the entry of <name> in the template. As to the remaining portions in the main body, the contents of the template is used. By setting a mail expiration date in the button, transmission of the electronic mail produced by electronic mail production unit 208 can be suppressed.

Mail server 104 looks into the main body of the received electronic mail, and sends electronic mail written with information corresponding to the requested product to the user. Not only information such as a catalog of the product, but also information promoting purchase such as a discount coupon or reservation information site can be attached. The user can browse the sent electronic mail through personal computer 105.

Program Example 2

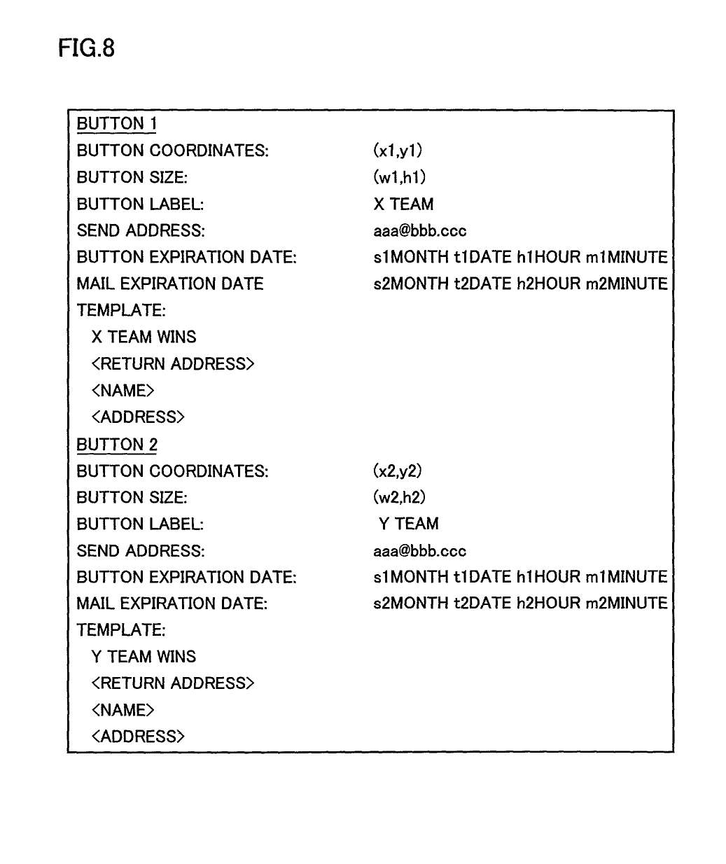

Consider the case where a baseball game is broadcasted as another example of a program to be received. A quiz such as which of team X and team Y will win can be issued during the program of the baseball game, and invite viewers to respond. A present will be given away to those who give the right answer by lottery. FIG. 8 shows an example of button data superposed on the video to be transmitted during the program of a baseball game. The button data includes data of button 1 and button 2. Display is provided so that button 1 is overlaid on the video of team X and button 2 is overlaid on the video of team Y. Since the contents of respective button data shown in FIG. 8 are similar to those shown in FIG. 6, detailed description thereof will not be repeated.

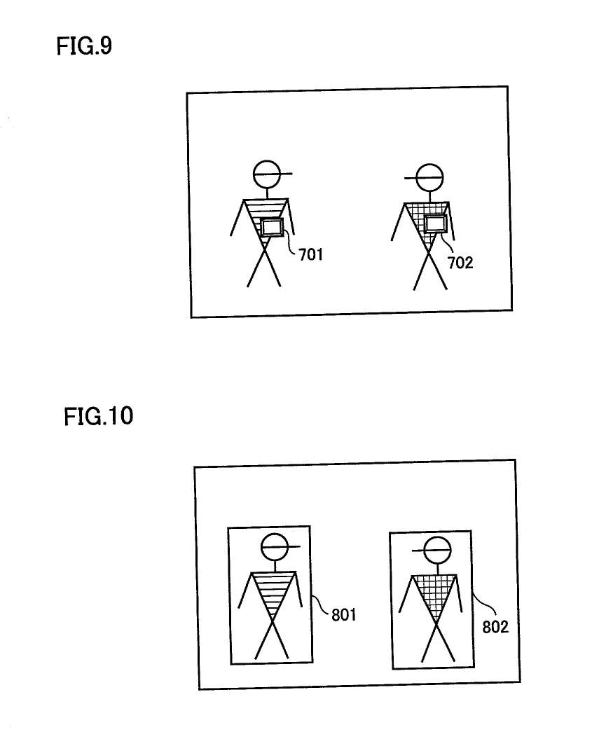

FIG. 9 shows an example of a display in which a button is overlaid on the video of a baseball game. Button 1 (701) and button 2 (702) are displayed on the video displayed on CRT 202, corresponding to team X and team Y, respectively. In the case where buttons 1 and 2 are virtual buttons not displayed, available regions 801 and 802 as shown in FIG. 10 may be displayed, assuming that the team of the available region corresponding to the location of the cursor is selected. As the video changes in the course of the program, data of the button coordinates and button size are resent, whereby different button coordinates and button size are set. It is also possible to eliminate the button upon the closing time of the questionnaire by setting a button expiration date.

The process when a button is selected is similar to that described for Program Example 1. Specifically, mail production unit 208 refers to button data corresponding to the button selected by the user to produce electronic mail. Mail transmission unit 209 sends the electronic mail produced by mail production unit 208 to mail server 104 through a public circuit.

Upon receiving electronic mail from a user, mail server 104 removes any unfair answers. For example, when there are a plurality of answers from the same one user, only the first received answer is rendered valid, and the remaining answers are taken as fraud. Since the electronic mail transmitted from a user is processed by mail server 104, the template of the electronic mail superposed on the broadcasted video does not necessarily have to be readable by a person as shown in FIG. 6 or 8. In the case where only the electronic mail corresponding to the data transmitted during the program is to be left and others removed, the electronic mail template can be transmitted in encrypted form and then decrypted at mail server 104. Thus, only the proper electronic mail can be processed.

Mail server 104 can accumulate the received electronic mail to determine a winner from those who give the right answer at the end of the game through lottery. Since information such as the address and name of the user is written in the contents of the electronic mail, the broadcast station can send the present to the address of the winner. Since announcement of the winner can be effected through the video during the program other than through the electronic mail means, it is not always necessary to transmit the electronic mail to the winner's personal computer 105.

By similarly producing a quiz program, a panel discussion program, or the like besides the above-described program examples, selection type questionnaire, polls, and the like can be conducted during the broadcasting period of a program.

According to the broadcast reception system of the present embodiment, broadcast receiver apparatus 102 provides a display with a button corresponding to video associated data on the video. Therefore, the user can readily grasp the correspondence between video and video related data. Since broadcast receiver apparatus 102 extracts a mail address and an electronic mail template from the button data superposed on the broadcast wave to produce electronic mail automatically for transmission, the user no longer has to place a telephone call or write a postcard, or produce electronic mail. At the broadcast station side, the answer to questionnaires and quizzes from users can be aggregated by just referring to the electronic mail accumulated in mail server 104. Therefore, the trouble to aggregate can be eliminated.

Second Embodiment

The broadcast reception system according to a second embodiment of the present invention differs from that of the first embodiment shown in FIG. 1 in the structure of the broadcast receiver apparatus and remote controller. Therefore, detailed description of likewise structure and function will not be repeated. In the second embodiment, the broadcast receiver apparatus and remote controller are labeled with the reference numbers of 102′ and 103′, respectively.

FIG. 11 is a block diagram showing a schematic structure of broadcast receiver apparatus 102′ ofthe second embodiment. Broadcast receiver apparatus 102′ includes a video/data separation unit 201 receiving a broadcast wave through an antenna not shown to separate a video signal from data, a CRT 202 displaying a received video or the like, a memory 203 storing data separated by video/data separation unit 201 (button data, video associated data), an infrared receive/emissive unit 205 transmitting/receiving data to/from remote controller 103′ through infrared radiation, a mail transmission unit 209 transmitting the electronic mail received from remote controller 103′, an LED 210, and a still picture production unit 211 extracting a still picture from the video and storing the extracted still picture in memory 203.

Still picture production unit 211 cuts out an image of one frame from the video separated by video/data separation unit 201, and reduces the size, if necessary, of the cut out image. This reduced image is stored in memory 203 as a still picture. The still picture is displayed in the display unit of remote controller 103′ to be used as a background image of button display. This still picture production unit 211 can be omitted if the remote controller lacks the function to display a still picture.

Upon receiving designation of obtaining video associated data from remote controller 103′, infrared receive/emissive unit 205 extracts and sends to remote controller 103′ button data stored in memory 203 and the still picture produced by still picture production unit 211. When there is video associated data corresponding to the button selected by the user, infrared receive/emissive unit 205 transmits the video associated data to remote controller 103′ in response to designation of video associated data, if any, from remote controller 103′.

As will be described afterwards, when electronic mail is produced by remote controller 103′, infrared receive/emissive unit 205 receives that electronic mail. Then, mail transmission unit 209 transmits the electronic mail received from remote controller 103′ to mail server 104 via a public circuit.

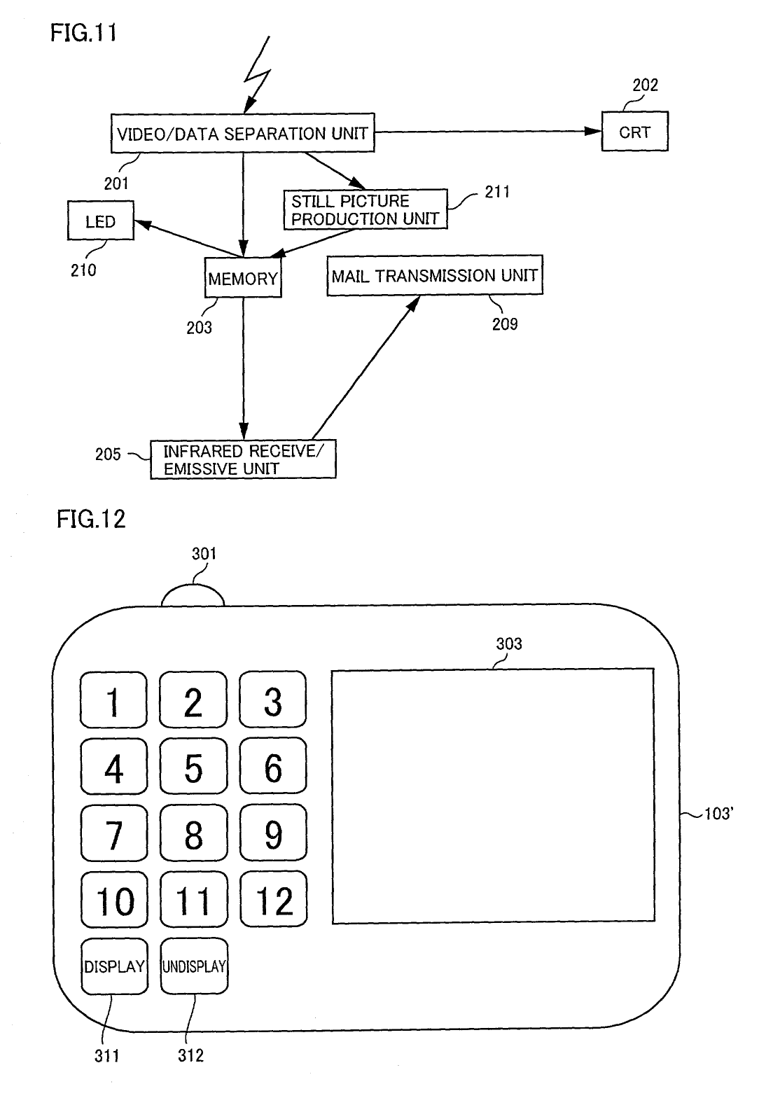

FIG. 12 shows an appearance of a remote controller of the present embodiment. Remote controller 103′ includes an infrared receive/emissive unit 301 that effects infrared communication with broadcast receiver apparatus 102′, a tablet-attached liquid crystal display (display unit) 303, a “display” button 311 designating display of a video associated button and cursor when video associated data is present, and an “undisplay” button 312 terminating display of the video associated button and cursor to display only the video.

When the user depresses “display” button 311, the mode is switched to the mode of displaying a video associated button. At this stage, infrared receive/emissive unit 301 designates broadcast receiver apparatus 102′ to obtain video associated data, and receives button data and a still picture from broadcast receiver apparatus 102′. The received still picture is displayed on tablet-attached display 303, and a button is displayed on the still picture. As the user touches the displayed button, tablet-attached liquid crystal display 303 enters the information and selection of the button is effected.

When video associated data is present corresponding to the selected button, the relevant video associated data is displayed on tablet-attached liquid crystal display 303. When there is no video associated data, information attached to the button data is referred to, and electronic mail is produced. The electronic mail is transmitted to broadcast receiver apparatus 102′ via infrared receive/emissive unit 301. When the user depresses “undisplay” button 312, the video associated button display mode is terminated, and no display is provided in display unit 303.

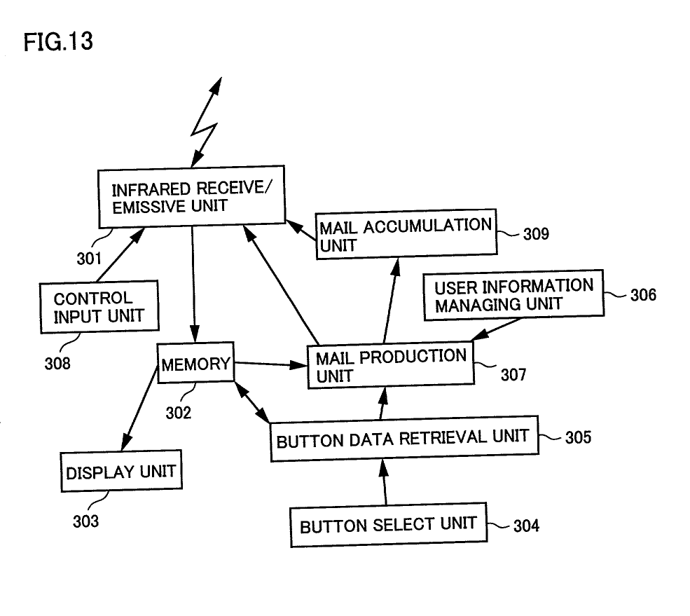

FIG. 13 is a block diagram of a schematic structure of remote controller 103′ of the present embodiment. Remote controller 103′ includes infrared receive/emissive unit 301 transmitting/receiving data to/from broadcast receiver apparatus 102′ through infrared radiation, a memory 302 storing data (button data, video associated data) received by infrared receive/emissive unit 301, a tablet-attached liquid crystal display (display unit) 303, a button select unit 304 selecting a button corresponding to the touched position on tablet-attached liquid crystal display 303, a button data retrieval unit 305 retrieving button data corresponding to the button selected by button select unit 304, a user information managing unit 306 managing preregistered user information, a mail production unit 307 referring to user information and the like under control of user information managing unit 306 to produce electronic mail, a control input unit 308 detecting depression of “display” button 311, “undisplay” button 312, and the like, and a mail accumulation unit 309 accumulating electronic mail produced by mail production unit 307.

Upon detection of depression of “display” button 311 by control input unit 308, infrared receive/emissive unit 301 sends a command to broadcast receiver apparatus 102′ to obtain video associated data, and receives button data and a still picture corresponding to the command from broadcast receiver apparatus 102′. The received button data and still picture are stored in memory 302. Display unit 303 displays a still picture stored in memory 302, and displays a button corresponding to the video of that still picture. It is possible to display only a button with a button label if display unit 303 lacks the function to display a still picture.

In response to selection of a button by a user touching display unit 303, button data retrieval unit 305 displays video associated data corresponding to the selected button, if any, in display unit 303. If there is no video associated data corresponding to the selected button, button data corresponding to that button is extracted to cause mail production unit 307 to produce electronic mail. The electronic mail produced by mail production unit 307 is transmitted to broadcast receiver apparatus 102′ by infrared receive/emissive unit 301. The electronic mail produced by mail production unit 307 can be accumulated in mail accumulation unit 309, and then transmitted together to broadcast receiver apparatus 102′. When remote controller 103′ is a composite apparatus with a telephone set that includes the function to transmit electronic mail, the electronic mail can be transmitted to mail server 104 directly through a public circuit.

In the present embodiment, a still picture is displayed in display unit 303 of remote controller 103′. Alternatively, a moving picture may be similarly displayed as in the case of broadcast receiver apparatus 102′. It is to be noted that portability is high since user information managing unit 306 is present in remote controller 103′. More specifically, even if the broadcast receiver apparatus is owned by the public and not by an individual, any user away from home who has viewed a broadcast through the broadcast receiver apparatus and wishes to obtain detailed information can specify the mail address of his/her personal computer at home, and then obtain the desired detailed information when back at home.

According to the broadcast reception system of the present embodiment, a button corresponding to video associated data is overlaid on a still picture in display unit 303 of remote controller 103′. Therefore, the user can easily grasp the correspondence between video and video associated data. Since remote controller 103′ extracts a mail address and an electronic mail template from the button data superposed on a broadcast wave to automatically produce electronic mail, the user no longer has to place a telephone call or write a postcard, or produce electronic mail. At the broadcast station side, answers to questionnaires and quizzes from users can be aggregated by just referring to the electronic mail accumulated in mail server 104. Since a button or the like is displayed in display unit 303 of remote controller 103′ and only the video is displayed in broadcast receiver apparatus 102′, the user can browse video associated data while viewing the general video. Therefore, usability is improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcast receiver apparatus comprising:
a separation unit separating video from data included in a broadcast wave, and
a display unit displaying the video separated by said separation unit, and displaying a button on said video based on button data included in said separated data,
wherein said display unit displays video associated data corresponding to a button selected by a user.

2. The broadcast receiver apparatus according to claim 1, further comprising:
an infrared receive unit receiving a command from an external source through infrared radiation,
a cursor move unit controlling movement of a cursor displayed by said display unit in response to the command received by said infrared receive unit, and
a button retrieval unit retrieving a button located at a position of said cursor,
wherein said display unit displays video associated data corresponding to the button retrieved by said button retrieval unit.

3. A broadcast receiver apparatus comprising:
a separation unit separating video from data included in a broadcast wave,
a display unit displaying the video separated by said separation unit, and displaying a button on said video based on button data included in said separated data,
a mail production unit referring to button data corresponding to a button selected by a user to produce electronic mail, and
a mail transmission unit transmitting the electronic mail produced by said mail production unit.

4. The broadcast receiver apparatus according to claim 3, further comprising:
an infrared receive unit receiving a command from an external source through infrared radiation,
a cursor move unit controlling movement of a cursor displayed by said display unit in response to the command received by said infrared receive unit, and
a button retrieval unit retrieving a button located at a position of said cursor,
wherein said mail production unit refers to button data corresponding to the button retrieved by said button retrieval unit to produce said electronic mail.

5. The broadcast receiver apparatus according to claim 4, wherein said mail production unit produces said electronic mail using a template included in button data corresponding to the button retrieved by said button retrieval unit.

6. The broadcast receiver apparatus according to claim 4, wherein said mail production unit produces said electronic mail using a mail address included in button data corresponding to the button retrieved by said button retrieval unit.

7. The broadcast receiver apparatus according to claim 4, further comprising a user information managing unit managing user information,
wherein said mail production unit produces said electronic mail based on user information under control of said user information managing unit.

8. A broadcast receiver apparatus comprising:
a separation unit separating video from data included in a broadcast wave,
a display unit displaying the video separated by said separation unit, and
a communication unit receiving an externally applied command, and transmitting video associated data included in the data separated by said separation unit to an external source.

9. The broadcast receiver apparatus according to claim 8, further comprising a still picture production unit producing a still picture from the video separated by said separation unit,
wherein said communication unit transmits button data included in the data separated by said separation unit, and the still picture produced by said still picture production unit to an external source.

10. A broadcast receiver apparatus comprising:
a separation unit separating video from data included in a broadcast wave,
a display unit displaying the video separated by said separation unit,
a first communication unit receiving an externally applied command to transmit button data included in the data separated by said separation unit, and receiving electronic mail from an external source, and
a second communication unit transmitting the electronic mail received by said first communication unit.

11. The broadcast receiver apparatus according to claim 10, further comprising a still picture production unit producing a still picture from the video separated by said separation unit,
wherein said first communication unit transmits the button data included in the data separated by said separation unit and the still picture produced by said still picture production unit to an external source.

12. A remote controller comprising:
a communication unit receiving data and an image from an external source,
a display unit displaying the image received by said communication unit and displaying a button on said image based on button data included in said data, and
a select unit selecting a button displayed by said display unit,
wherein said display unit displays video associated data corresponding to the button selected by said select unit.

13. A remote controller comprising:
a communication unit receiving data and an image from an external source, and transmitting electronic mail to an external source,
a display unit displaying the image received by said communication unit, and displaying a button on said image based on button data included in said data,
a select unit selecting a button displayed by said display unit, and
a mail production unit referring to button data corresponding to the button selected by said select unit, and producing said electronic mail.

14. The remote controller according to claim 13, wherein said mail production unit produces said electronic mail using a template included in button data corresponding to the button selected by said select unit.

15. The remote controller according to claim 13, wherein said mail production unit produces said electronic mail using a mail address included in button data corresponding to the button selected by said select unit.

16. The remote controller according to claim 13, further comprising a user information managing unit managing user information,
wherein said mail production unit produces said electronic mail based on user information under control of said user information managing unit.

17. A broadcast reception system including a broadcast apparatus superposing video and data on a broadcast wave for transmission, a broadcast receiver apparatus receiving the broadcast wave transmitted from said broadcast apparatus, and a remote controller controlling said broadcast receiver apparatus,
wherein said broadcast receiver apparatus comprises
a separation unit separating video from data included in the broadcast wave transmitted from said broadcast apparatus,
a display unit displaying the video separated by said separation unit, and displaying a button on said video according to button data included in said separated data, and
a select unit selecting a button displayed by said display unit in response to designation from said remote controller,
wherein said display unit displays video associated data corresponding to the button selected by said select unit.
